(19) United States
(12) Patent Application Publication
(10) Pub. No.: US 2015/0095176 A1
(43) Pub. Date: Apr. 2, 2015

(54) Domain Name Marketplace With Mobile Sales And Brokerage Platform

(71) Applicants: Frank Taylor Schilling, Grand Cayman (KY); Ying Han, Grand Cayman (KY)

(72) Inventors: Frank Taylor Schilling, Grand Cayman (KY); Ying Han, Grand Cayman (KY)

(21) Appl. No.: 14/043,280

(22) Filed: Oct. 1, 2013

(51) Int. Cl. G06Q 30/06

(52) U.S. Cl. CPC G06Q 30/0601
USPC 705/26.1

(57) ABSTRACT

An online platform for the listing and sale of internet domain names includes a web server for receiving purchase inquiries from buyers and a messaging facility for communicating inquiries to sellers who have listed domain names for sale through the platform. A mobile communication application provides sellers with immediate access to purchase inquiries, valuation tools, consultation facilities and brokerage delegation tools by which sellers may efficiently engage buyers in response to purchase inquiries. The online platform leverages the ability of domain names to identify an online location in order to use the domain name itself as a communication channel, in addition to facilitating other channels of communication between buyer and seller.

### CROSS REFERENCE TO RELATED APPLICATIONS

Priority is claimed herein to U.S. Appln. No. 61/708,213 filed Oct. 1, 2012.

### FIELD OF THE INVENTION

The present invention relates to online systems, methods, and a mobile platform for facilitating the purchase, sale, and brokerage of internet domain names.

### BACKGROUND

Internet domain names have become more than simply a method of accessing content on the internet. An internet domain name can become the identity of a business operating on the internet. As the popularity of the internet as a commerce platform has expanded, the demand for descriptive, short, common phrase or otherwise memorable domain names increased. At the same time, it was found that such domain names attracted type-in traffic which could be monetized by the use of paid keyword-relevant advertising content for such domain names. These factors drove an interest in domain names themselves as investment vehicles which provide inherent resale value and income. Because each internet domain name is unique, and the value of a domain name may range from a few dollars to a few million dollars, it is difficult to manage the conduct of valuation, negotiation, and management of purchase offers across a large portfolio.

### SUMMARY OF THE INVENTION

In accordance with one aspect of the present invention, there is provided an online platform for receiving and communicating domain purchase inquiries by buyers and responses by sellers which, unlike trade in tangible goods, utilizes the ability of a domain name itself to provide a communication vehicle for sales negotiations. A visitor to a web page denominated by a domain name of interest is enabled to submit a purchase inquiry, and to receive responses from the buyer via the web page itself. In accordance with another aspect of the present invention, efficient online communication by the buyer and the seller is facilitated by the use of a mobile platform by which the seller, or a selected broker, is enabled to engage purchase inquiries, and to communicate with the buyer through the denominated web page as well as by a variety of other communication channels as a negotiation proceeds. In accordance with yet other aspects of the invention, the online platform provides tools for valuation and monetization of domain names, along with tools for delegating or consulting with others on the course of a negotiation.

### BRIEF DESCRIPTION OF THE DRAWINGS

The invention as described herein will best be understood in connection with the attached drawings in which:

FIG. 1 is a block diagram of internet-connected platforms utilized by the present invention;

FIGS. 2-7 and 17-19 are web pages generated by a listing platform of the invention;

FIG. 8 is a state diagram of interactive menus generated by a mobile platform operating in accordance with the invention, and in which the reference numerals correspond to menu displays generated by the mobile platform; and

FIGS. 9-16 and 20-30 are menu displays generated by the mobile platform.

### DETAILED DESCRIPTION

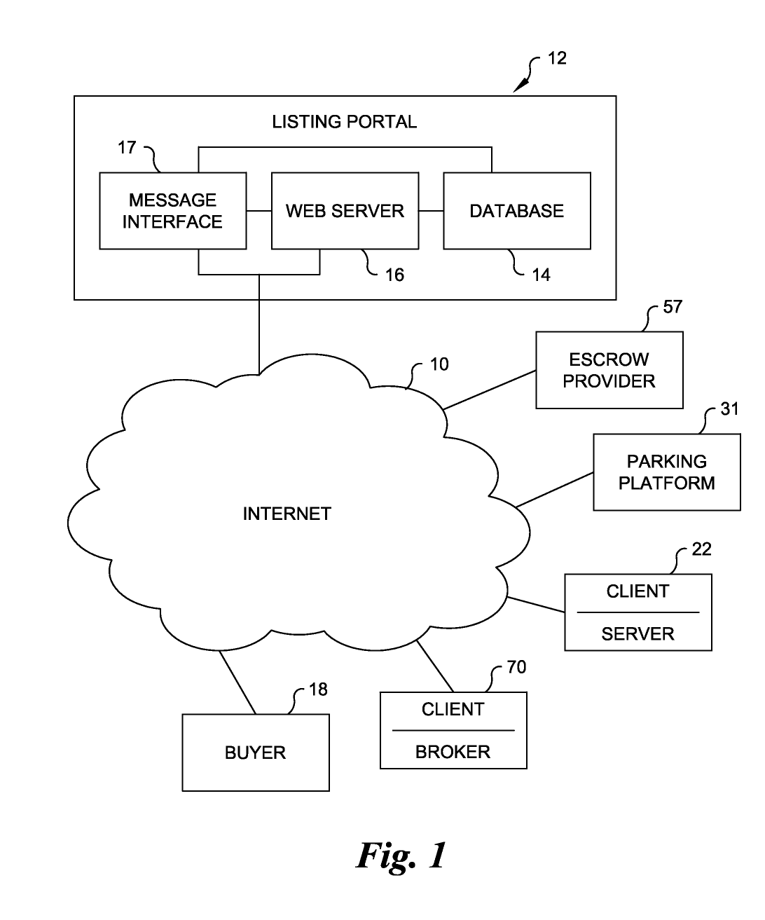

Referring now to FIG. 1, there is shown a multi-user interactive marketing system according to the present invention. Connected to the internet 10 is a listing portal 12. The listing portal 12, comprises a database 14, described in more detail below, for maintaining records used in the method of the present invention; a web server 16 for providing interactive web pages described below; and a message interface for conducting electronic message and email functions described below. The listing portal 12 further provides a registration facility by which users of the system of the present invention seeking to advertise domain names for sale may establish a listing account to advertise the availability of domain names for sale. Upon establishing an account with the portal 12, a user identifies one or more domain names constituting a portfolio of domain names for which the user is the registrant, broker, or other person with authority to advertise or sell the domain names in the portfolio. The database 14 is operatively connected with the web server 16 to provide a searchable database of domain names in the user portfolios, and to accessibly record other data described below in the course of executing methods of the invention, including purchase inquiries, communications conducted in the course of negotiating the purchase and sale of domain names, consultative communications among users of the system, listing prices for each or any of the domain names in the respective portfolios, a history of quoted prices for each name, and recorded contact information of prospective buyers. In alternative embodiments, the database 14 may also be configured to query domain sales listing databases operated by other domain secondary market providers, such as domain registrars and domain resellers.

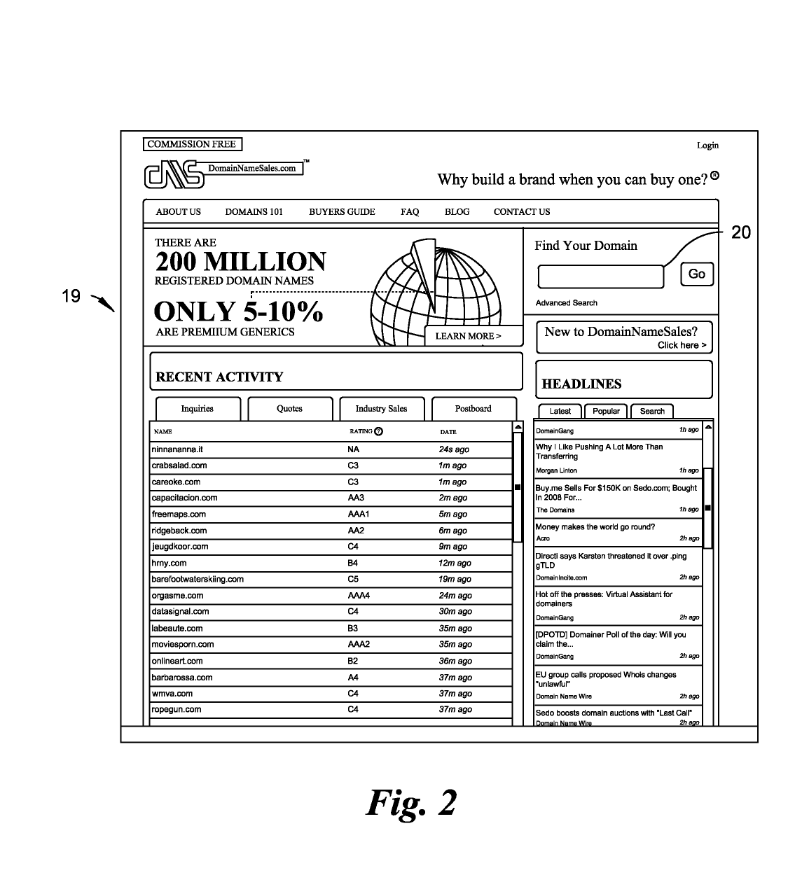

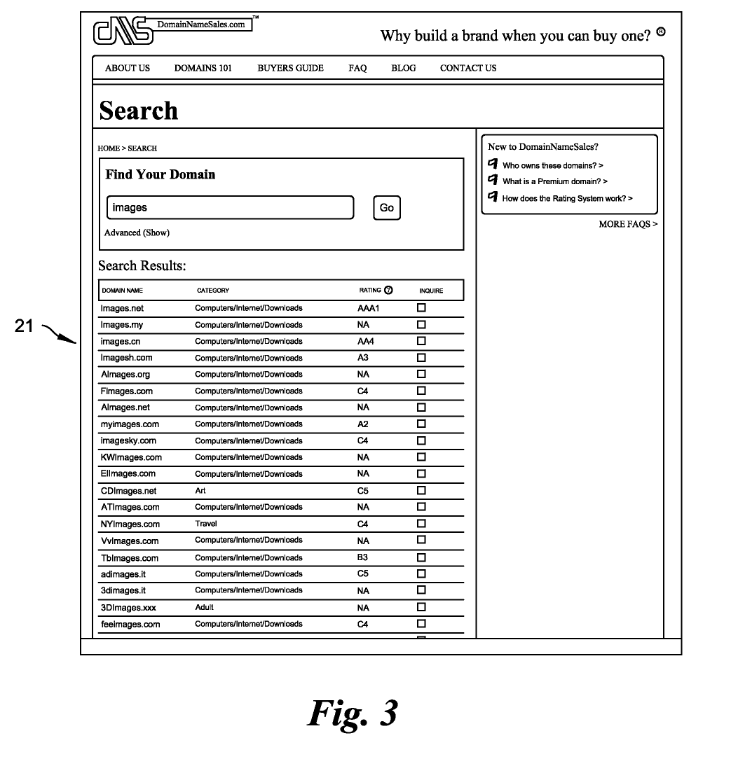

According to one embodiment of the invention, a buyer 18 may access the listing portal 12 via the internet 10 to find domain names listed for sale by users of the listing portal. Such access is provided by the web server 16 providing a search interface by which the buyer 18 may search listed domain names containing keywords or other character sequences or combinations of interest to the buyer 18, in order to be informed of a domain name of interest to the buyer 18. For example, a portal home page 19 is shown in FIG. 2, including a search box 20 for conducting a search of domain names listed with the portal 12. Referring to FIG. 3, there is shown a sample search result for the word “images”. As can be seen therein, in response to the search entry, the portal 12 queries the database 14 to retrieve a list of domain names responsive to the search and to generate an interactive display of search results 21, which in the present example includes the domain name images.net.

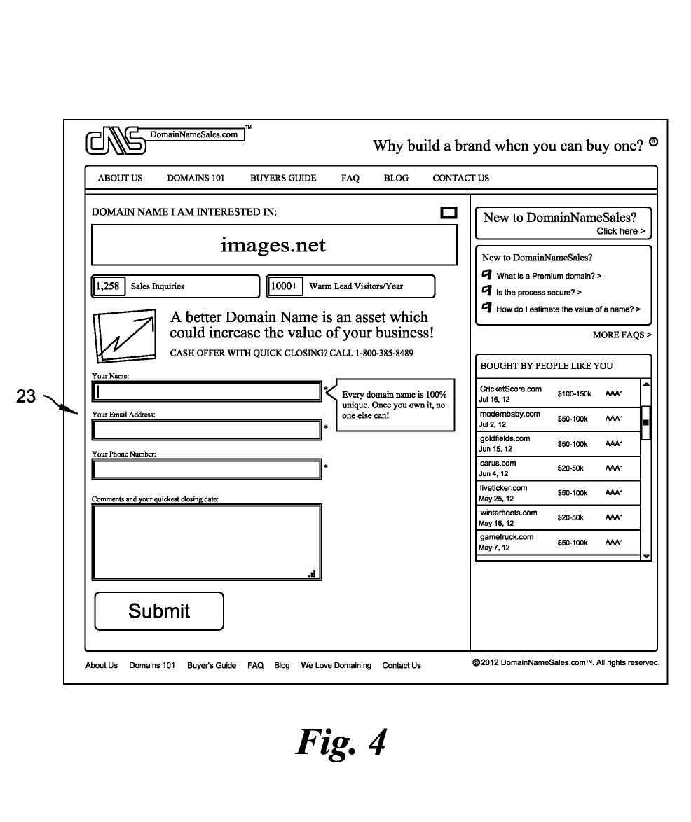

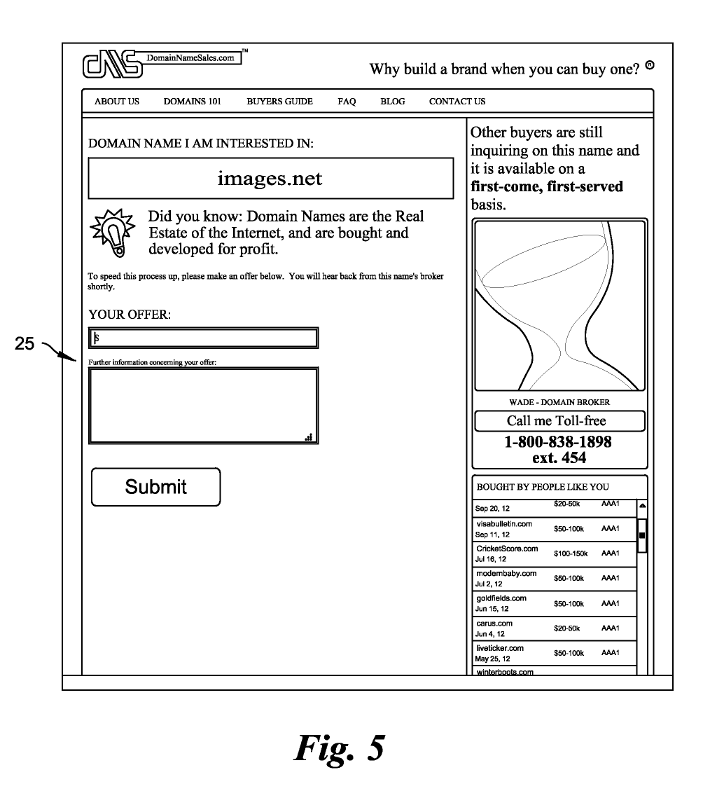

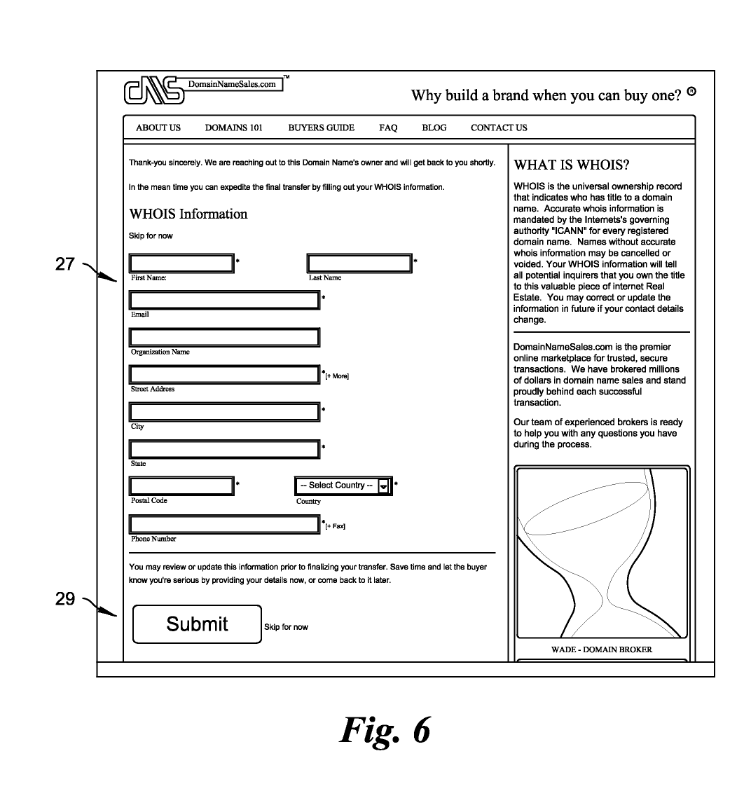

Upon the buyer 18 selecting a domain name of interest from the list, such as images.net, the portal 12 generates and presents to the buyer a web page comprising an interactive inquiry initiation form 23 shown in FIG. 4, by which the buyer may enter the buyer's identifying information along with comments, questions or other information as free form text. When the buyer has entered the buyer's information and optionally other text into the inquiry initiation form 23 and has elected to proceed, the portal 12 generates and presents the price offer form 25 shown in FIG. 5, where the buyer is prompted to make an offer for the domain name. The portal 12 may optionally enforce a minimum price set by the seller in connection with the listing of the domain name in the database, prior to permitting the buyer to submit an offer and other data provided to the portal by the buyer. After the buyer has submitted an inquiry, the portal 12 generates and displays an interactive registration data entry form 27 shown in FIG. 6. The registration data entry form allows the buyer to enter the eventual domain registration data, or WHOIS data, so that transfer of the domain name can be expedited upon acceptance of the buyer's offer, or the result of negotiation further mediated by the system of the present invention. In an alternative embodiment, the buyer 18 may have identified a domain name for sale by visiting the website corresponding to a domain name in which the buyer has interest, rather than visiting the portal and conducting a search. In such an embodiment, the corresponding to the domain name is configured by the domain name registrant or manager of the website, to include a link from the corresponding website to the inquiry initiation dialog of FIG. 4.

Referring again to FIG. 1, after a buyer has submitted an inquiry, such as an offer, via the listing portal 12, the listing portal records the inquiry data provided by the buyer in association with the domain name in the database 16, and enters the inquiry into a notification queue of the messaging interface 17 of the listing portal 12. The listing portal 12 further generates and sends to the messaging interface 17 an email message to be sent to the seller containing the offer and a link to the listing portal, so that the seller can reply to the inquiry via email, or by accessing the listing portal to perform the negotiation and other functions described below.

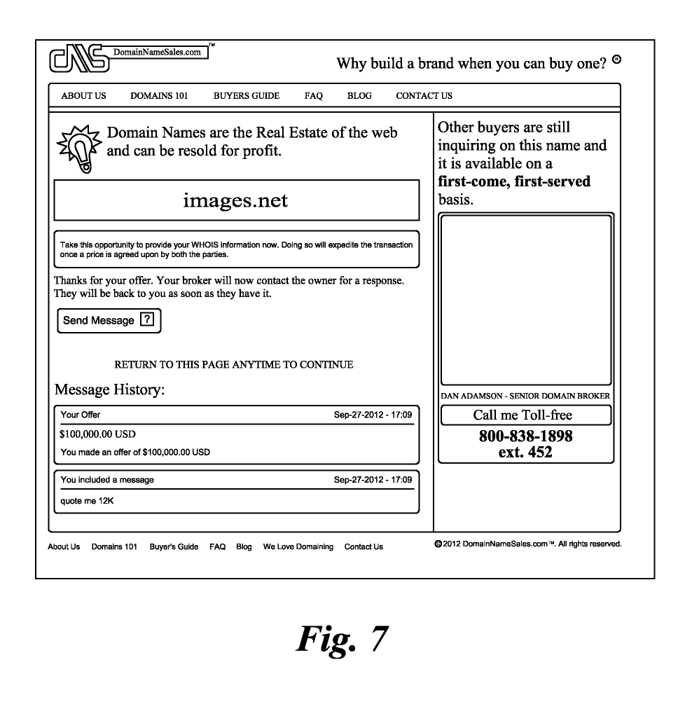

When a buyer has submitted an inquiry, the portal 12 additionally sets a cookie on the buyer's platform to contain a record identifier. The record identifier stored in the cookie enables the portal to continue to associate the buyer's platform with the present inquiry, and with other inquiries made by the buyer if any, in order to enable further communication sequences intermediated by the portal 12 and described further below. When the buyer has completed the entry of WHOIS data, or opted to skip the entry thereof according to the option buttons 29 shown in FIG. 6, the listing portal 12 proceeds to generate and present to the buyer a confirmation display, shown in FIG. 7, which presents the buyer with the buyer's inquiry data, confirms that the buyer's inquiry has been directed to the seller of the domain name, and permits the buyer to add supplemental information to the inquiry. The confirmation display further informs the buyer to return to the indicated page to receive updates in connection with the inquiry.

In a preferred embodiment, domain names listed for sale are hosted by the web server 16 and the web server is configured to provide a designated web page for each domain name hosted by the web server 16. Such a designated web page may be a provided by configuring the web server 16 to generate a type of web page known as a parking page, which displays advertisements retrieved from a paid advertising database on the basis of keywords within the domain name itself. Such parking pages earn revenue on the basis of “pay per click” (PPC) or affiliate advertising, so that while domain names are listed for sale on the platform, the domain names earn revenue as a consequence of visitors arriving at the page and clicking through to an advertiser identified on the page. Likewise, the designated web page may have a search bar, along with pre-loaded search suggestions or categories configured for the domain name, which activate searches of paid advertisements by which the web server retrieves or generates a request to an advertising database (not shown), displays of advertisements response to a user-initiated search via the search bar, or by clicking on one of the pre-loaded search suggestions. By configuring the web server 16 to provide such parking pages, the domain names listed on the platform earn revenue while being listed for sale. The database 14 maintains a record of visitor traffic to the listed domain names and revenue earned by the domain names, which can be useful metrics to assess the value of the listed domain names as, for example, a multiple of PPC earnings over a period of time.

Accordingly, the sales listing platform of the present invention platform further provides a valuation mechanism for the listed domain names. In a particularly preferred embodiment, a link is provided from the parking page to the inquiry initiation form 23 such that a visitor who has arrived at the parking page by navigating to the domain name, and may be interested in purchasing the domain name, may proceed to initiate an inquiry, as described above. Such action will, as described above, set a record identifier cookie on the visitor's platform, so that subsequent visits to the domain name by that buyer can be detected by the web server 16 to direct the buyer to the confirmation display of FIG. 7, to apprise the buyer of updates to their inquiry, such as further offers, acceptance, or other communications provided by the system of the present invention. Hence, the web page provided by the web server to other visitors be the default designated web page, while the web page provided by the web server to a buyer will be the confirmation page provided upon completion of the sales inquiry form.

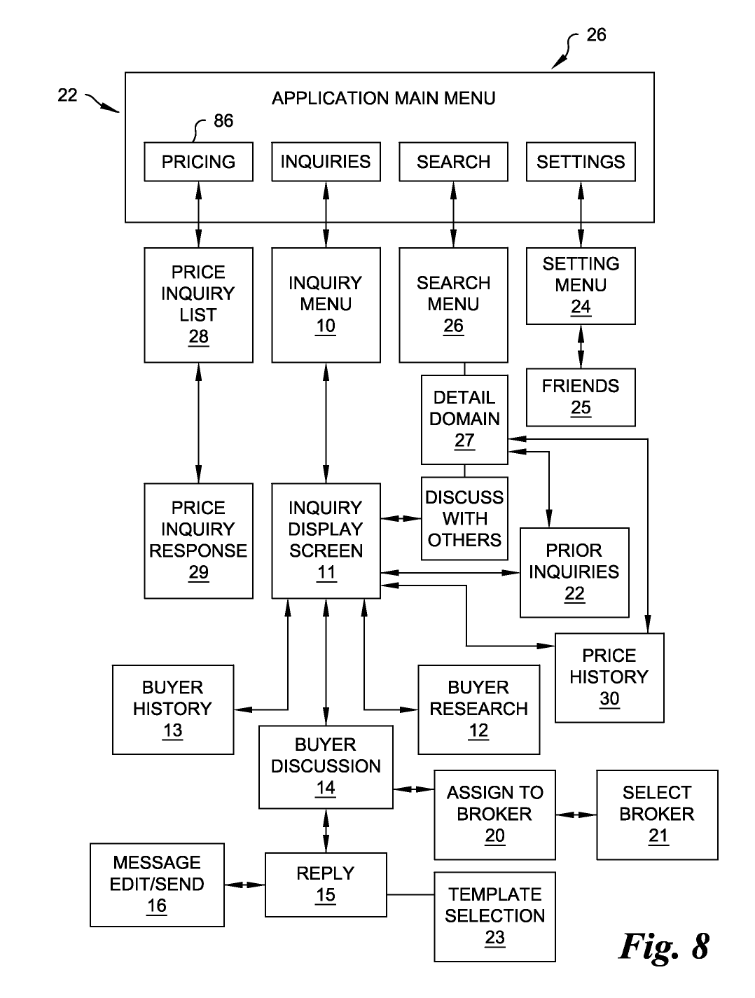

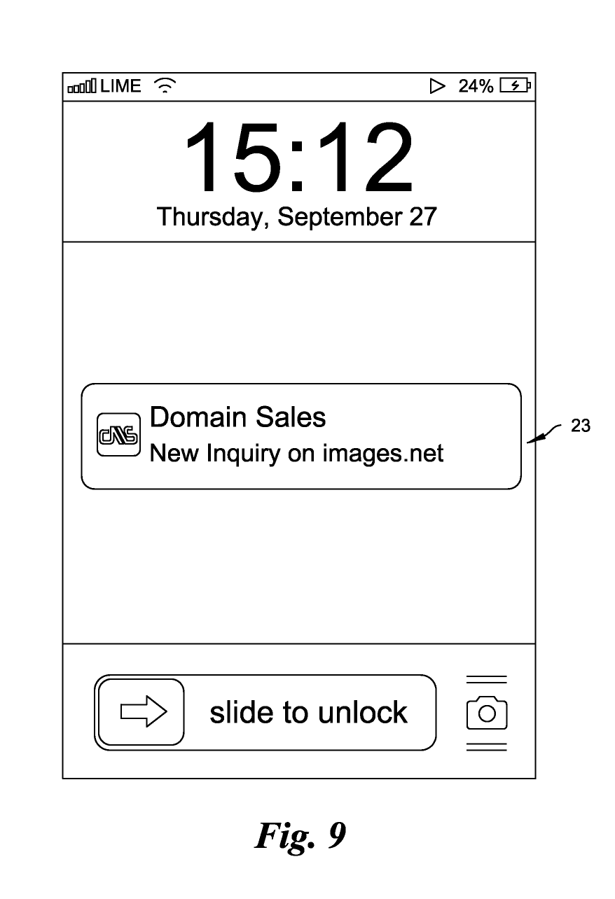

The seller, who may be the domain registrant or other user as described below, is provided with a client platform 22 for interacting with the listing portal 12. In the preferred embodiment, the client platform is a software application loaded onto a smartphone, such as an Apple iPhone or Android compatible. Alternatively, the client platform may reside on a tablet, laptop or other computing device either as resident software or by connecting to the listing portal itself via a browser in order to engage in the research, consultation and response procedures described below. The client platform 22 is configured to provide an menu-driven interface 26 by which the user may receive inquiry notifications, along with the other functions as will now be shown and described in connection with FIG. 8. Continuing with the present example relating to a purchase inquiry for images.net, the client platform 22 receives instant notification of the new inquiry from the notification queue managed by the listing portal 12 by, for example, a “push notification” of a known type, and generates a notification to the user, such as the instant notification 23 shown in FIG. 9. Upon being alerted to the new inquiry, the user may launch the client platform interface 26, to select from several courses of action described below. The client platform interface 26 connects with the portal 12 to access the database 16 via the internet, and the client platform interface 26 provides navigable menus by which the platform retrieves recorded data from the database 16 to enable the seller to review and respond to buyer inquiries, conduct research relating to the buyer and the domain name under consideration, communicate and confer with other users of the system, review historical price quotes and other communications conducted via the system, and other actions described below.

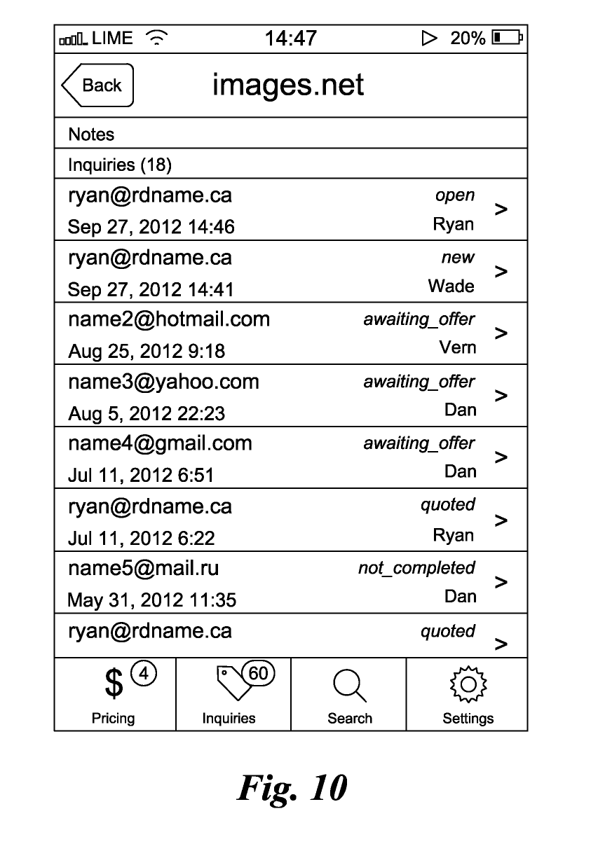

The client platform 22, includes an inquiry response and tracking module 24, for which an exemplary screen display is shown in FIG. 10. As shown therein, the inquiry response and tracking module accesses the portal 12 to retrieve and present a list of inquiries which the user has received, arranged by domain name, and further indicates “active” inquiries, which are newly received or for which a negotiation is in progress; and a historical record of previous inquiries, for which negotiations or other communications have concluded. In the preferred embodiment, received inquiries are presented to the user in the order of most recently to least recently received.

Upon selecting the most recent inquiry or, as in the present example in response to entry to the platform application from a push notification, the platform 22 proceeds to access the listing portal database 16 to generate an interactive inquiry display screen 30 shown in FIG. 10. The inquiry display screen 30 provides a display of statistical and historical information relating to the domain name, such as statistical data 32 which may include such information as an identification of the portfolio to which the name belongs, traffic rank within the portfolio, revenue rank within the portfolio, monthly earnings, keyword targeting, or other information which may assist the user in assessing and tracking the performance and value of the domain name. The statistical data 32 may have been uploaded to the portal database 16 by the user when the portfolio was established or further edited at a later time. In the preferred embodiment the statistical data 32 is retrieved and presented from a domain performance tracking system such as a domain parking platform 31 at which the domain name is parked and which is accessible to the listing portal to retrieve traffic statistics, revenue statistics, keyword targeting and other data.

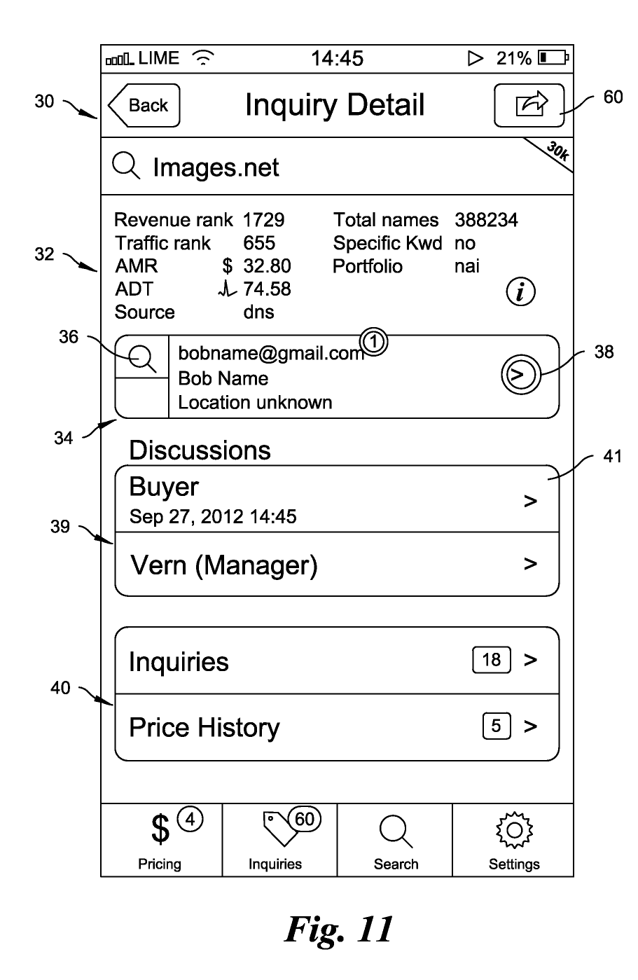

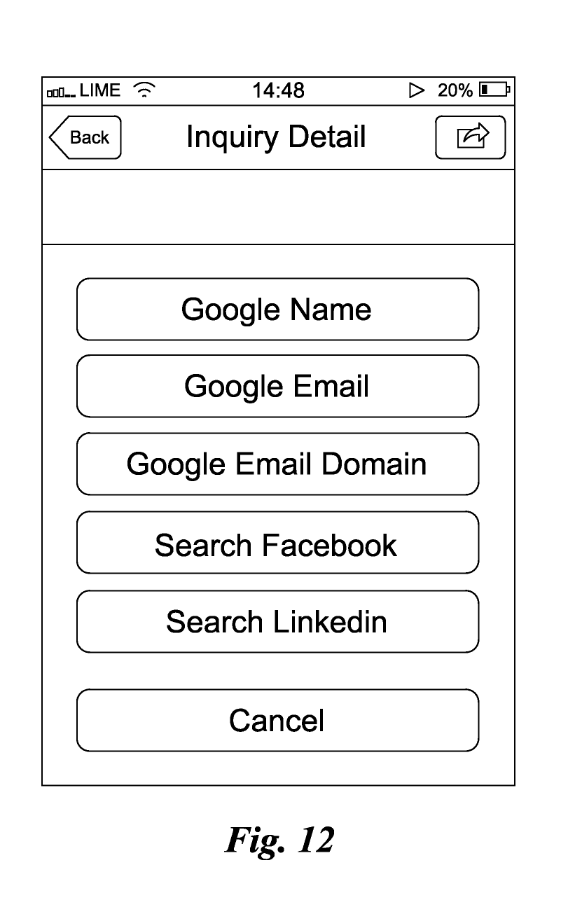

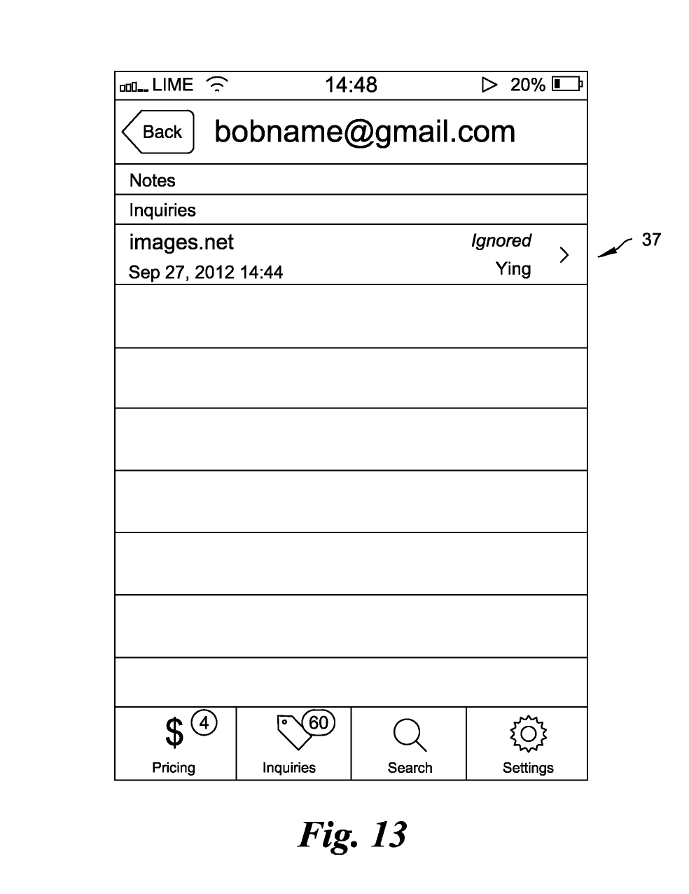

The buyer 18 who generated the inquiry is identified in a buyer identification section 34 of the interactive inquiry screen 30, according to information provided by the buyer when the inquiry was made, such as by name, email address and location. The buyer identification section 34 includes a buyer research button 36, to enable the user to find other information about the buyer 18. Activating the buyer research button produces the display shown in FIG. 12 by which selected buyer information may be passed by the platform to online resources such as by conducting searches on the buyer's name, email address, email domain, and social network identities corresponding to the buyer's identification data. Activating any of the buyer research functions performs the indicated search of third party resources, such as Google, Facebook, or LinkedIn, to provide the user with further information about the buyer in order to enable the user to obtain information about the buyer and determine the reputation of the buyer, in assessing the inquiry. Referring again to FIG. 11, the buyer identification section 34 further includes a buyer history button 38 which, upon activation, causes the platform 22 to retrieve from the portal 12 a buyer history list 37 (FIG. 13) of prior inquiries and associated communications which have been received and conducted with the identified buyer. By providing such tools to research the buyer's identity and previous interactions with the buyer, the user may reach an informed decision on how to engage the buyer based upon the buyer's reputation and results of previous interactions with the buyer. In the present example, as shown in FIG. 13, the buyer history list 36 indicates the present inquiry to be the first received from the present buyer 18. If the buyer had previously engaged in negotiation communications with the user, such previous interactions would be displayed by domain name in the buyer history list 36.

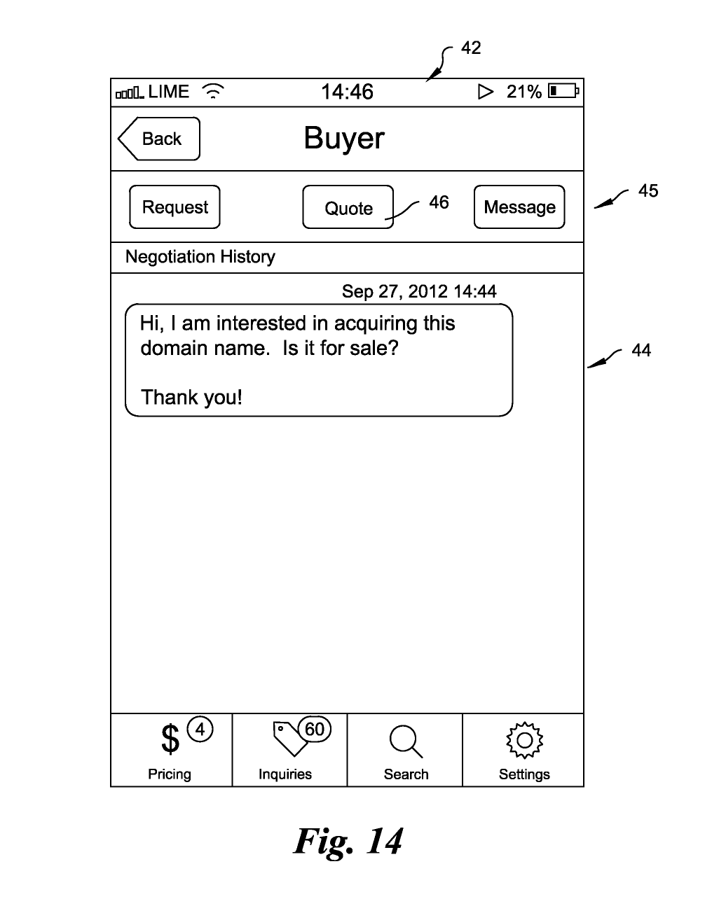

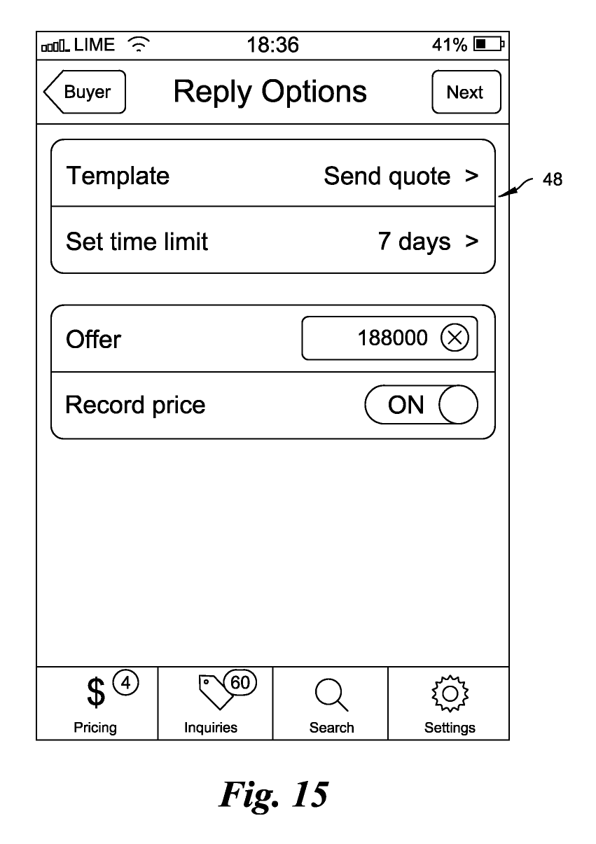

Referring again to FIG. 11, below the buyer identification section 24, the inquiry display screen 30 provides a discussion access menu 39 by which the user may retrieve and conduct discussions with the buyer, and with others to be discussed below. Activating the buyer discussion menu option 41, causes the platform 22 to launch a negotiation dialog display 42 relating to the present inquiry, shown in FIG. 15. In the negotiation dialog screen 42, the buyer's inquiry comments, price offered, or other information entered by the buyer 18 in connection with the present inquiry, is displayed in a negotiation history section 44, and the user is provided with several options for responding to the buyer's inquiry. The ensuing dialog is stored by the portal server database 16 and accessible to the client platform 22, so that via the negotiation history section 44, the user is provided access to the history of negotiation communications ensuing from the inquiry submitted by the buyer. Response options provided by the negotiation dialog display 42 include the menu buttons 45 identified in FIG. 14 as “request”, “quote” and “message”, to provide the indicated functions. For example, in response to the present inquiry, the user may decide to provide the buyer with a price quote, by activating the quote button 46, causing the platform to produce a quote generation menu 48 shown in FIG. 15.

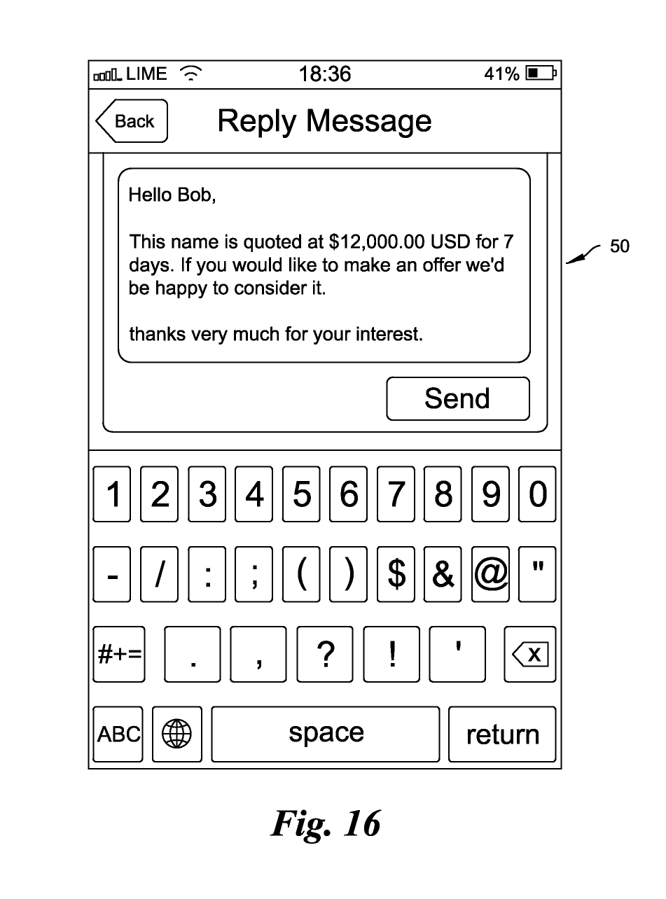

The quote generation menu 48 provides the user with the ability to specify price quote to send to the buyer. Using a default template shown in FIG. 16, the user may specify the amount of the quote, a time limit for which the quote is valid, and opt to record the price in a quote history associated with the domain name, described further below. When the user has completed the quote generation menu 48, the platform 22 proceeds to a response message and editing display 50 shown in FIG. 16. In the response message and editing display, the data entered into the quote generation menu is integrated with a quote template standard text in the form of a quote to be sent to the buyer. If the user is satisfied with the response, the user taps “send” and the response is sent to the listing portal server 22 for storage in the database 16, and the portal 12 performs further steps described below.

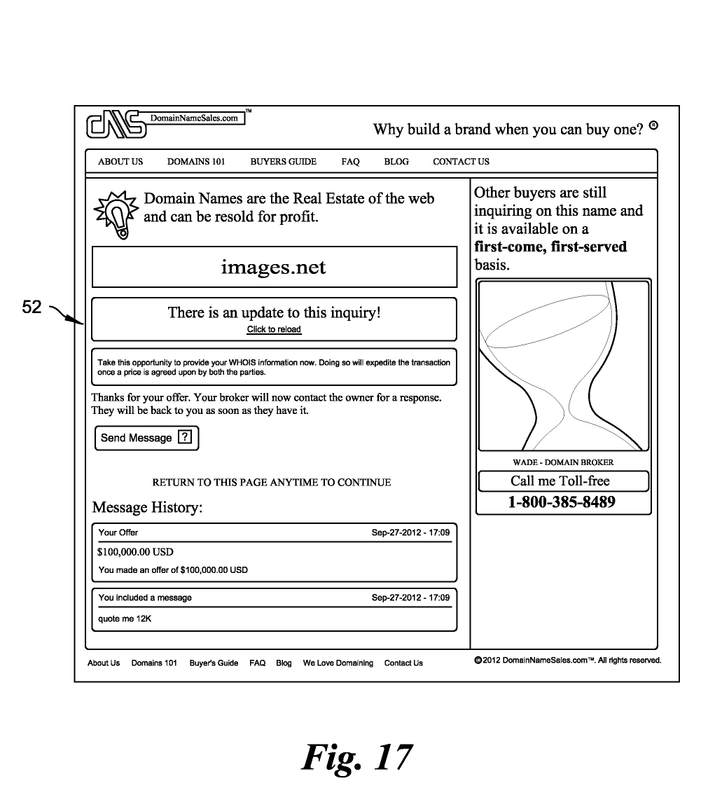

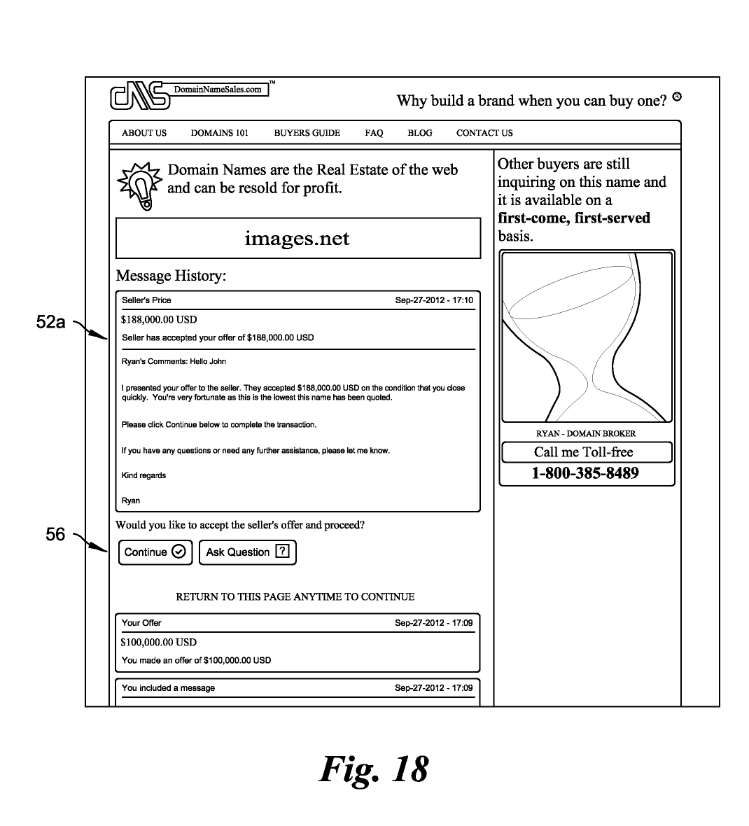

The system of the present invention is configured to notify the buyer of the seller's response, preferably through multiple parallel mechanisms. Upon receiving a response to an inquiry by the user, the listing portal generates and sends an email to the buyer via the portal messaging interface 17, containing the seller's response and including a link back to the listing portal, such as to the inquiry confirmation page discussed in connection with FIG. 7. When the buyer returns to the listing portal using the emailed link, or remains on the inquiry confirmation page, the portal retrieves the transaction identification stored in the cookie on the buyer's platform, or likewise encoded in the email link, and generates a notification dialog box 52 on the confirmation page informing the buyer that the seller has responded to the offer, as shown in FIG. 17. Having submitted an inquiry and proceeded to enter WHOIS information or otherwise have proceeded to the confirmation page, the buyer's browser may still be located at the confirmation page, independent of having navigated elsewhere and returned from the link in the notification email message. In either event, the portal will update the confirmation page to notify the buyer that the seller has responded and to provide the buyer with the seller's response. In the preferred embodiment, the web pages generated by the portal employ Asynchronous JavaScript and XML (AJAX) or other known techniques to enable live updates to the web pages generated by the portal, such that portions of an active web page may be updated asynchronously to provide immediate interaction between the buyer and seller via the inquiry confirmation page. The notification dialog box 52 may prompt the buyer to click on a link therein to show the seller's response, or may provide the response directly. In either event, the seller's response is displayed to the buyer in the notification dialog box 52a as shown in FIG. 18.

Continuing with the present example, the seller has responded with a quote as described above, and the quote response is shown in the notification dialog box 52a. When, as in the present example, the seller's response is a quote, an acceptance of an offer submitted by the buyer, or where the buyer and seller have otherwise agreed on a price in the course of communications, the portal generates and displays button links 56 prompting the buyer to accept the agreed upon terms, or to further communicate with the seller. In the event the buyer opts to further communicate with the seller, by activating the “ask question” link, the portal generates and provides an additional text entry form for submission of further communications in association with the inquiry. Such further communications proceed as has been described, in which the portal receives successive communications, stores the communications in the database in association with the inquiry, immediately notifies the parties of successive communications, displays the communications to the buyer and seller via their respective platforms for accessing the portal, and likewise transmits email messages to the parties containing the successive communications to the parties as the negotiation proceeds. Likewise, ongoing negotiation communications in connection with an inquiry are retrieved and displayed as a conversation in the negotiation dialog display 44 of the user platform 22 described in connection with FIG. 14, to which the user is prompted by push notifications to the platform 22 when the buyer responds to each successive communication, or which is refreshed on a live basis while the user is engaged with the negotiation dialog display 44. In the present example, when an agreement has been reached, the buyer may commit to the negotiated result by clicking the “continue” button shown on the confirmation page 56.

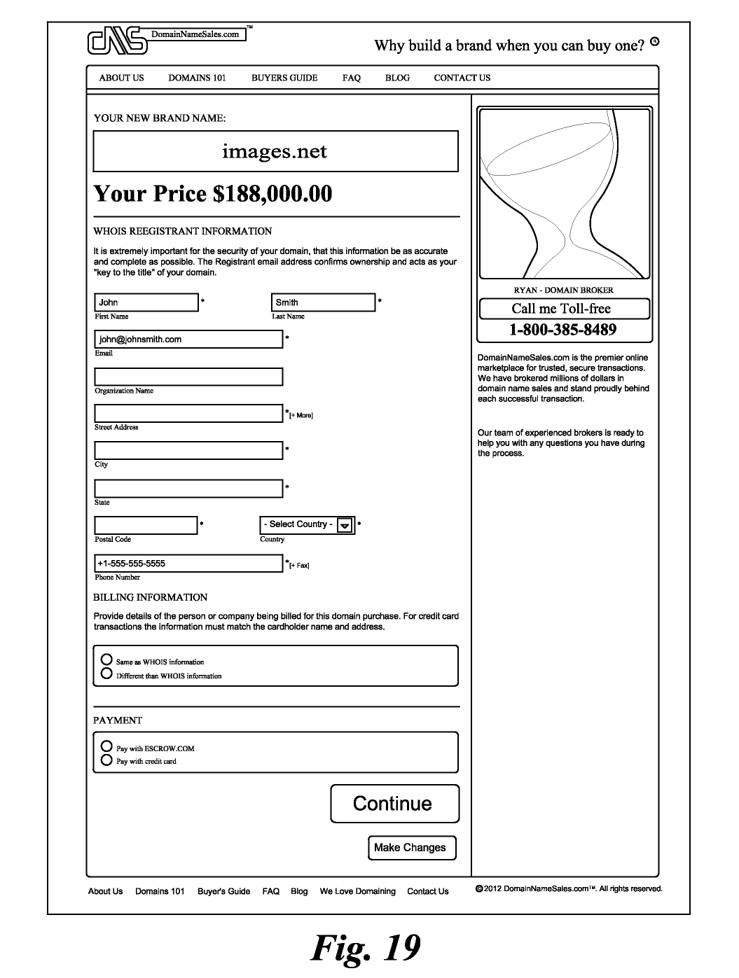

Upon the buyer accepting a negotiated result of the inquiry and electing to proceed to purchase of the domain name via the confirmation page, the portal proceeds to generate and display an interactive payment information form shown in FIG. 19. The interactive payment form is used by the buyer to provide billing information for the transaction, including the buyer's billing contact identification and method of payment, such as by credit card, bank wire, online payment system, and other known payment methods. As domain name purchases frequently involve substantial amounts, the purchase price, billing information, and payment method information collected by the portal at the close of a transaction may be exported directly to an escrow provider 57 for establishing an escrow transaction under which the escrow provider 57 collects payment from the buyer, notifies the seller, and then transfers payment to the seller after the escrow provider 57 receives confirmation that the domain name has been transferred from the seller to the provider. In the preferred embodiment, the portal is configured to export the transaction information, including the seller contact, the buyer contact, the domain name, and the purchase price to a known online escrow provider 57, Escrow.com, sufficient to allow the creation of an escrow transaction and to perform the escrow function for completing the agreed sale. In an alternative embodiment, the portal server database may include a sales contract template into which the agreed sales terms are inserted into a form contract by which the buyer and seller may select performance terms such as method of payment, closing date, escrow provider, governing jurisdiction and other material terms, in order to generate a contract in printable or electronic form for execution and delivery by the parties to the sale.

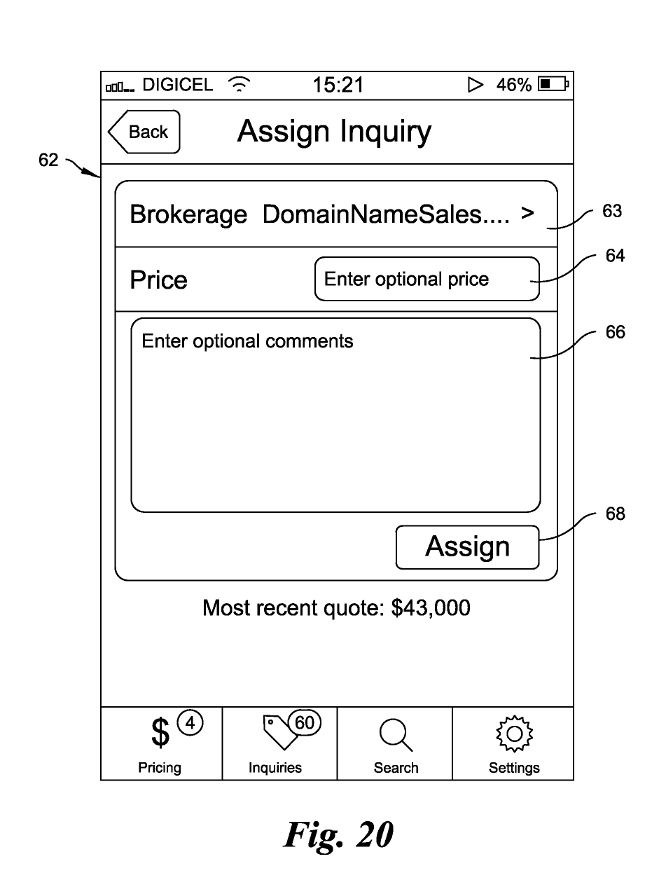

As can be appreciated, the system of the invention in accordance with the example method of use thus far described, provides a mechanism for immediate and rapid response to a purchase inquiry and facilitates a real time discussion and negotiation between the user and the buyer. In accordance with additional preferred features and methods of the invention, the portal 12 is further configured to facilitate consultative features by which a user may confer with selected consultants, assign an inquiry to a broker for response, or conversely permit a broker to confer with the domain registrant or associate brokers, during the course of responding to an inquiry or conducting a negotiation. Referring again to FIG. 11, the inquiry display screen 30 includes features by which the user may elect to consult with others prior to responding to the inquiry, or to assign further negotiations concerning the inquiry to a broker. For example, the inquiry display screen includes a “send” button 60 by which the inquiry may be assigned to a broker who is a registered user of the portal 12 and has registered to receive brokerage inquiries via the portal 12. In order to assign the inquiry to such a broker, the user taps the “send” button 60, elects to assign the inquiry, and the user platform 22 generates and displays a interactive brokerage assignment form 62 shown in FIG. 20. The brokerage assignment form 62 provides a brokerage selection option field 63, indicating the broker to which the inquiry is to be assigned; a “price” field 64 into which the user may indicate their lowest acceptable price; and a free-form text field 66 in which the user may provide additional instructions to the broker. The brokerage assignment form 62 further displays the most recently quoted price for the domain name, retrieved from the portal database 16. Upon completing the price field 64, the user may tap the “assign” button 68 in order to send a broker assignment message to the portal 12. In response, the portal 12 records and transmits the inquiry and the assignment information provided by the user to the selected broker, for example, broker 70 shown in FIG. 1. The broker 70 may then proceed, using the mobile user platform 22 or the listing portal website, to engage the buyer in the same manner as described above in connection with the direct user negotiation of the domain name images.net.

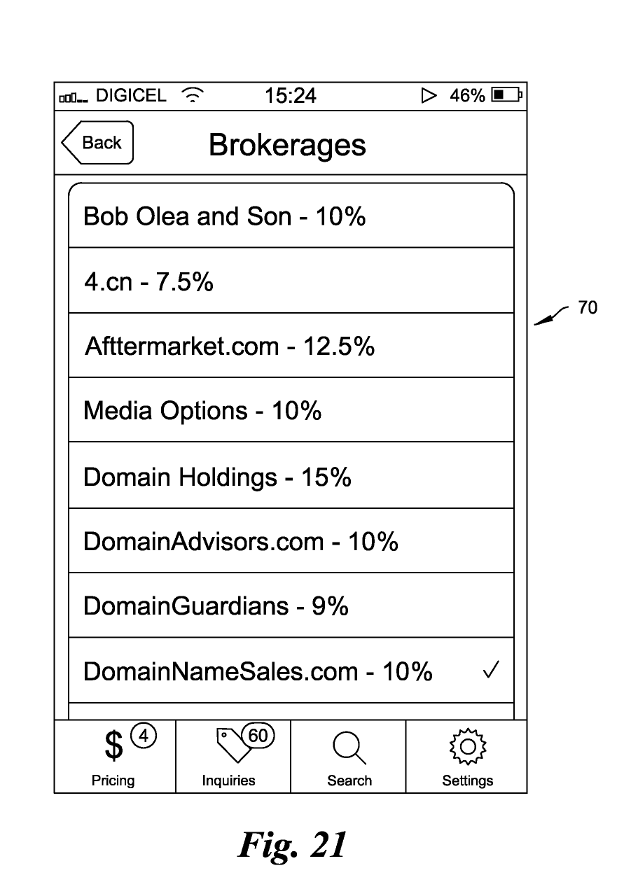

The platform 22 further provides a mechanism by which a user may select any of several brokers registered with the system. Referring again to FIG. 20, the brokerage assignment indicator is an active field which may be selected by the user to cause the platform 22 to retrieve from the portal database 16 a selectable list of registered brokers as shown in FIG. 21. The brokerage selection list 70 displays the names and other information, such as current commission rates, of brokers registered with the portal 12 from which the user may select a preferred broker to whom to assign the inquiry before returning to the assignment form 62 and transmitting the assignment.

Referring again to FIG. 11, where an inquiry involves more than one user, for example a domain registrant, an employee thereof, a brokerage, and/or a broker assigned to an inquiry, the inquiry notification display 30 identifies such additional parties to the negotiation in the discussion access menu 39. Hence, while the discussion with the buyer proceeds, the user handling the inquiry may further select any of the additional persons shown in the discussion access menu to ask questions or otherwise transmit information relating to the inquiry to such other interested persons. Activation of any of the additional parties identified in the discussion access menu causes the platform 22 to launch a dialog display, similar to that described above in the negotiation dialog display conducted with the buyer, in which the portal 12 retrieves the relevant discussions held with the indicated party in the course of handling the inquiry, and to permit further conversation to continue by means of the notification, messaging, and email facilities of the portal 12. Hence, while conducting a negotiation with the buyer, the broker may communicate with the listing seller about additional or alternative terms that may be proposed during the negotiation, and receive immediate responses from the seller to avoid stagnation of the negotiation, overlooked emails, or scheduling difficulties which arise in connection with traditional general purpose communication mechanisms such as telephone calls.

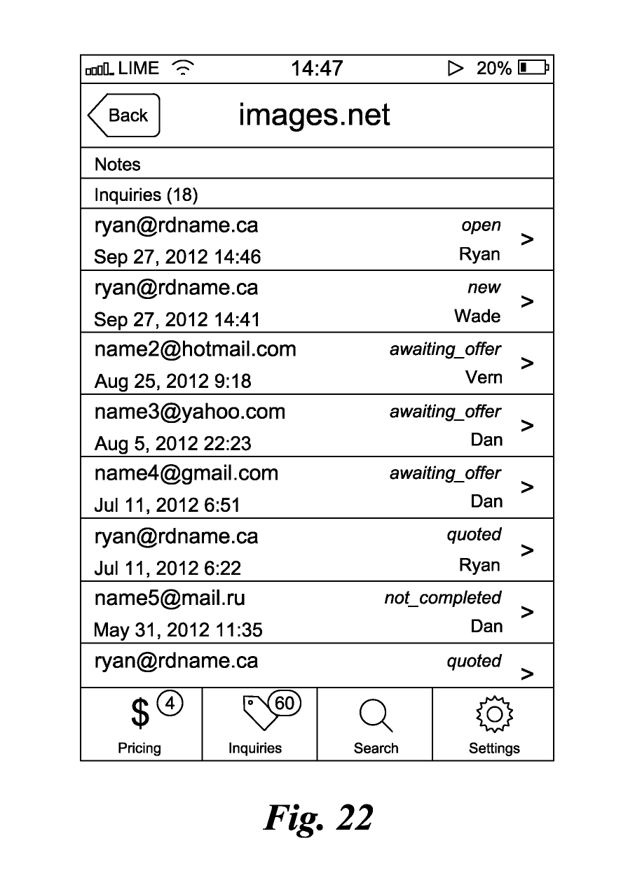

To further facilitate management of sales negotiations relating to a domain name, the inquiry notification display 30 further provides access to recorded data maintained by the portal 30 relating to other inquiries which have been made in connection with the domain name of interest. For example, a domain name may be subject to multiple present or past inquiries, and such other buyers may maintain an interest in proceeding with negotiations. Likewise, the broker or seller may desire access to quotes or offers which have previously been made in connection with the domain name. These functions are facilitated by the selectable options indicated as “inquiries” and “price history” in a menu 40 which, upon selection of an option retrieves the indicated recorded data in order to display respective lists of prior inquiries and offered prices and quotes. Selecting the “inquiries” options in the menu 40 causes the platform 22 to retrieve and generate a list of the previous inquiries which have been received for the domain name, as shown in FIG. 22. As shown therein, the previous inquiry list is preferably arranged by buyer, and includes a short description of the current status of negotiations held in connection with the other inquiries, which may be indicated as “open”, “quoted”, “new”, “awaiting offer”, “not completed” or similar indications providing an immediate view of the status of previous or parallel negotiations. The user may further select any of the other inquiries listed in inquiries menu to proceed to the relevant inquiry management form pertaining to that inquiry. Hence, if a present inquiry appears to be proceeding toward a sale, the user may communicate to concurrent or previous prospective buyers that the domain name may soon be sold and invite bids competitive with the price offered by the present buyer, or otherwise determine whether any of the other inquirers maintains a continued interest in purchasing the domain name. By providing access to all related inquiries in connection with a domain name, the platform provides the user with an organized management tool for conducting multiple parallel negotiations with all interested purchasers and can thus determine which among such inquirers is willing to pay the maximum selling price for the domain name. Likewise, the user may conduct such multiple parallel negotiations in the form of an auction, by notifying participating buyers of successive price updates until the auction is concluded.

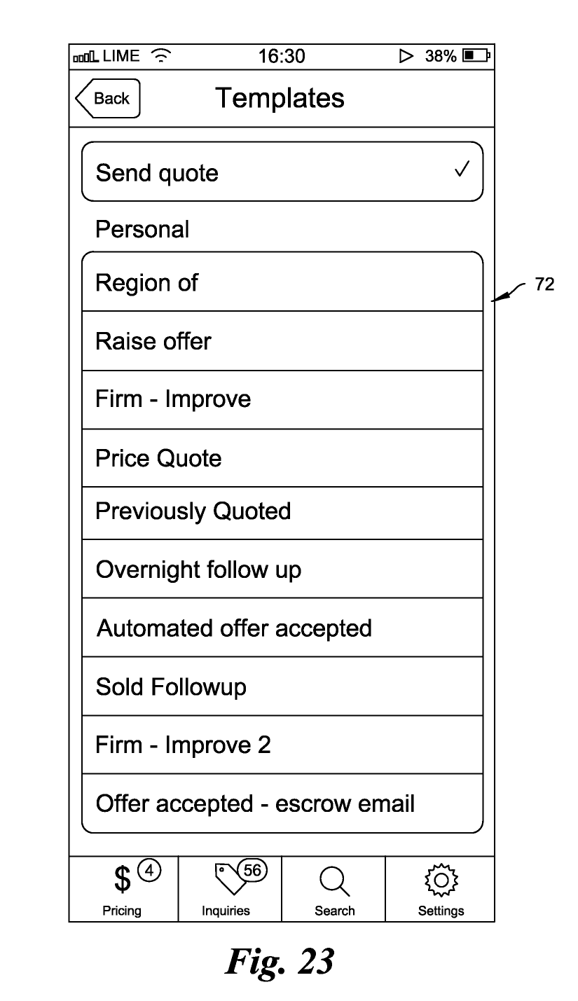

As noted above in connection with FIG. 14, the platform 22 provides access to a variety of templates for generating and sending standard responses to an inquiry. The primary responses shown in FIG. 14 include “request”, by which the platform 22 generates a standard form requesting a price quote from the buyer; and “message” by which the platform 22 provides a free-form text entry screen by which the buyer may produce a custom response. Each of these menu options causes the platform 22 to produce a default template for the indicated type of communication as discussed in connection with FIG. 15. Further, as shown in FIG. 15, the response display screen includes access to a template menu which may be activated by tapping the indicated template, whereby the platform 22 provides a template selection menu 72, shown in FIG. 22 by which the user may select any of several pre-loaded templates for providing standard response text to the editing display 50. The “price quote” template has been discussed above. Exemplary templates include standard negotiating responses indicated in FIG. 23 as:

“Region of”—for indicating a general price range
“Raise offer”—for requesting a higher offer from the buyer without specifying a counter-offer
“Firm—Improve”—the listed price is firm, and the buyer should increase the offer
“Previously Quoted”—for informing the buyer of a previously quoted price
“Overnight follow up”—for informing the buyer that the seller will respond at a later time
“Automated Offer Accepted”—for accepting the buyer's offer and proceeding to closing
“Sold Followup”—for post-sale communications
“Offer Accepted escrow”—for informing the buyer of acceptance, and notifying the user's preferred escrow service to establish a transaction

The user may also establish, in association with the user's portal account, any number of custom templates containing pre-loaded text for standard negotiation communications for storage in the portal database 16. The provision of selectable template responses facilitates rapid responses to the buyer which, as noted above, may reach the buyer very shortly after the buyer has initiated an inquiry and may still be visiting the portal 12. Hence, the platform 22 provides a mechanism by which a user may respond to a sales lead and to engage the buyer very near the time the buyer has expressed an initial interest in a domain name.

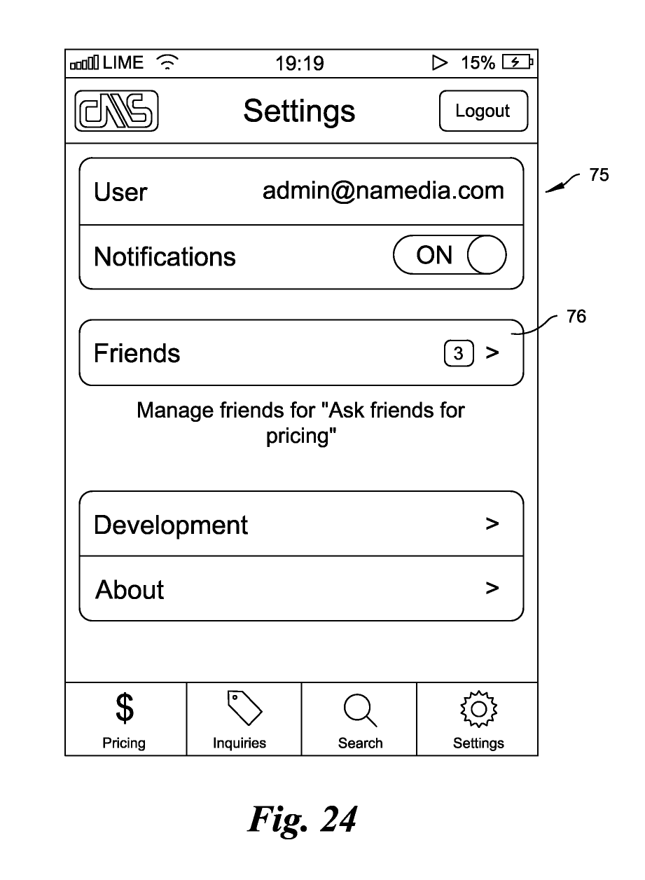

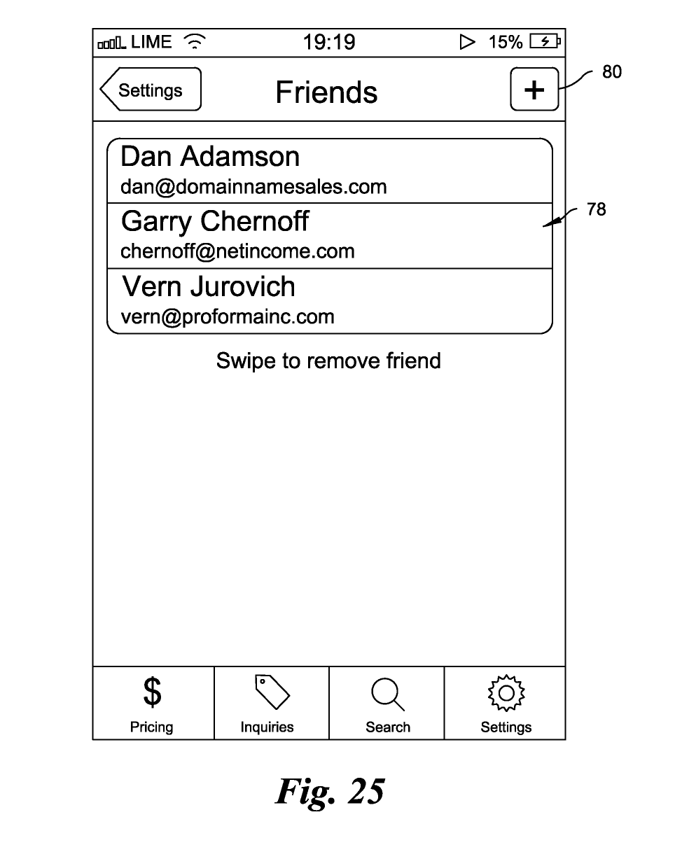

The platform 22 is further configured to provide consultative features which may be employed in the course of inquiry-driven methods described above, or independent of inquiry-driven methods. By selecting the “settings” option of the main menu 26, the platform 22 provides the user with user settings menu 75 including a “friends” menu option 76 shown in FIG. 24 by which the user may identify other users of the system as persons whom the user may designate as consultants for referring questions which may arise in connection with the domain names listed or brokered by the user. Selecting the friends menu option 76 in the user settings menu activates an editable friend list display 78 shown in FIG. 25 by which the user may view a list of other users of the system with whom the user may consult in relation to pricing of names, or other questions such as legal issues which may arise in connection with a domain name listing. The user may delete existing friends from the list, or include additional friends using the “add” button 80 and subsequently entering the name, email address or account identification of the desired friend registered with the portal 12.

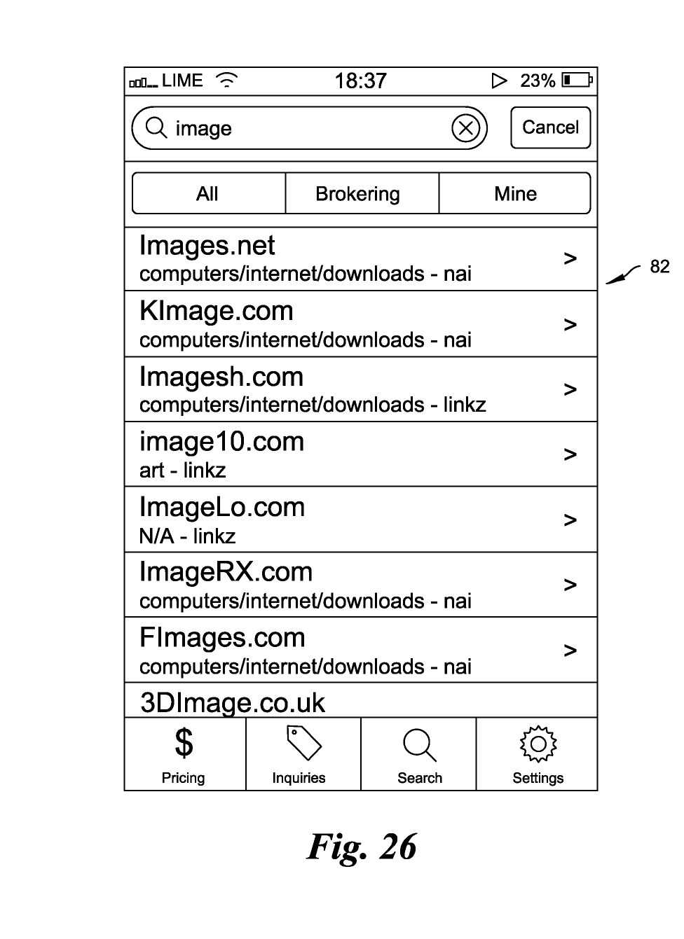

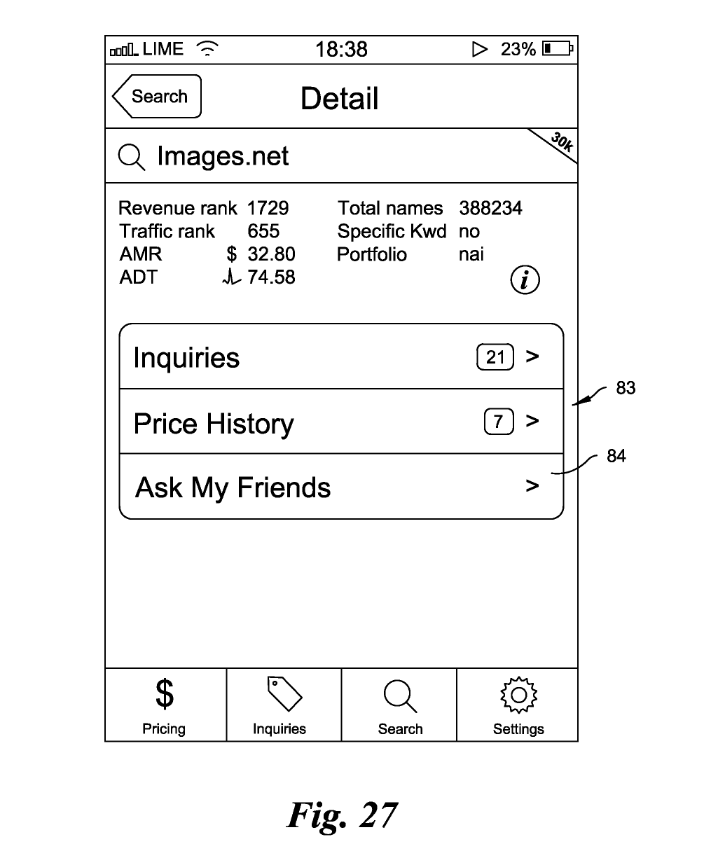

When a user has designated friends, the inquiry response form may include an “ask friend” feature among the options displayed in connection with assessing an a specific inquiry, as described above, or independent of a specific inquiry as follows. By selecting the “search” option from the main menu 26, the platform 22 generates an interactive search display shown in FIG. 26 by which the user may enter a search string to retrieve from the portal 12 a list 82 of domain names containing the entered string. The search results may be further filtered to show all domains listed with the portal 12, those domain names for which the user is acting as broker, or those domain names for which the user is the owner as indicated by the corresponding tabs in FIG. 26. Selecting a domain name, such as images.net, from the responsive list of domain names owned or brokered by the user causes the platform to launch an interactive domain detail menu 83 shown in FIG. 27 which displays statistical and historical information about the selected domain name, including an “inquiries” option for accessing the interactive inquiry list associated with the domain name; a “price history” option for accessing the offer and/or quote history associated the domain name; and further includes an “ask my friends” menu option. Activating the “ask my friends” option 84 launches a message dialog (not shown) in which the user may send a query to all or a selection of the user's friends. In the preferred embodiment, such a query includes a request for the friend to send the user a suggested price for the domain name. The portal 12 records the query, sends an email to the selected friends, and additionally sends a push notification to the selected friends, by which the friends are immediately alerted to the query.

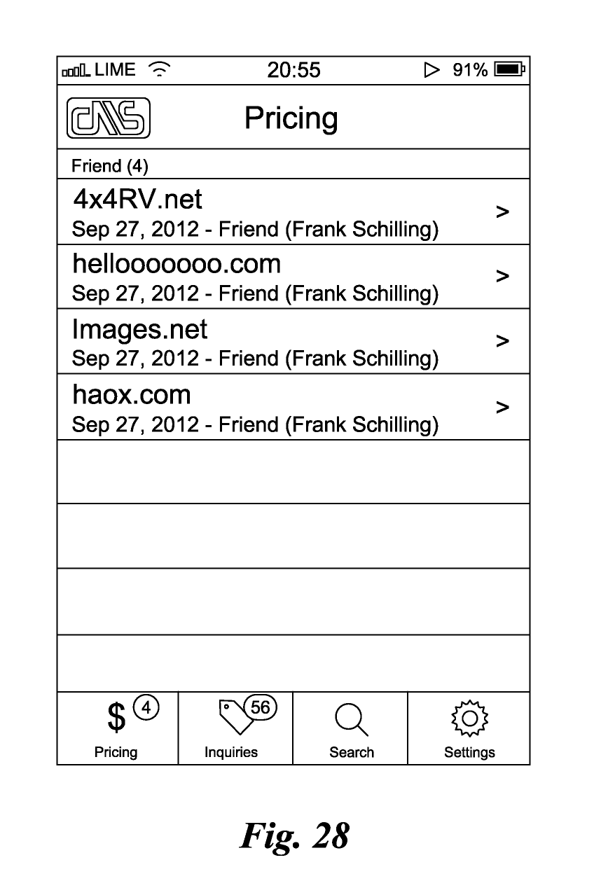

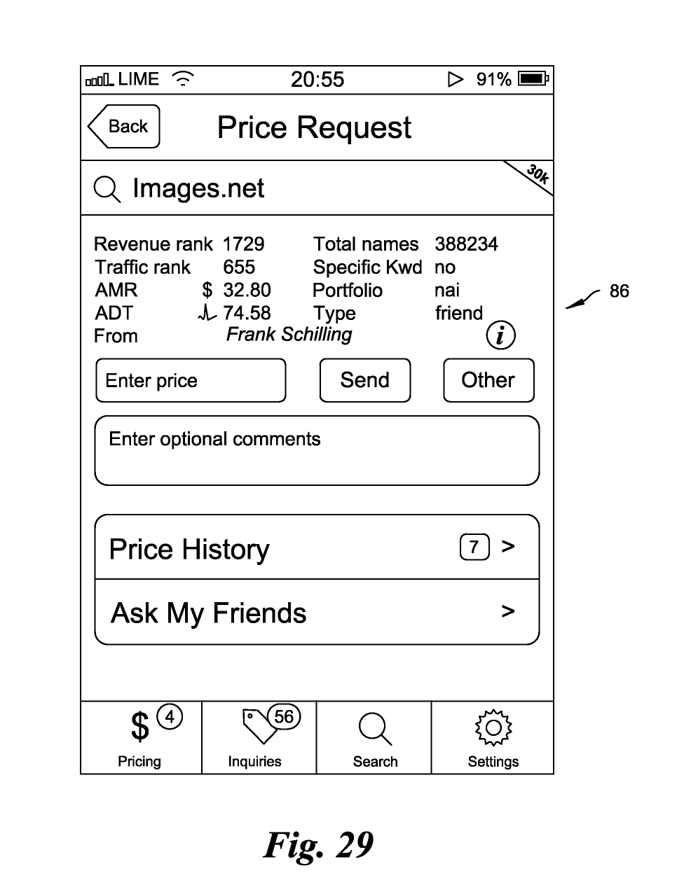

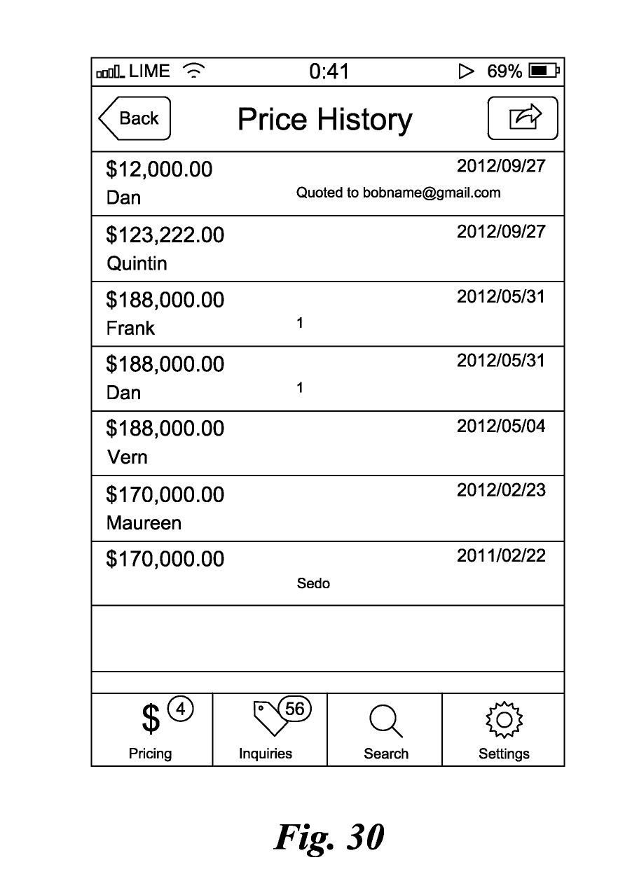

Pricing inquiries from friends are accessed under the “pricing” option 86 of the main menu 26. Accessing the pricing menu option launches the interactive price inquiry list FIG. 28. The price inquiry list presents the user with a list of domain names for which the user's friends have requested pricing opinions. For example, selecting images.net from the price inquiry list activates a price request response form 86 shown in FIG. 29 by which the user may specify a proposed price for the domain name and/or enter additional comments in connection with the proposed price. When the user completes the price request response form, the proposed price and other commentary is sent to the portal 12, is associated by the portal 12 with the price history of the domain name, and becomes accessible to the listing user under the “price history” menu option accessible from the inquiry response display of FIG. 11, and from the “price history” menu option accessible from the domain detail menu display 27, for consultation in connection with the present inquiry or future inquiries relating to the domain name.

While invention has been described hereinabove by way of illustration and description of preferred embodiments thereof, it will be understood that the invention extends to modifications and variations thereof within the scope of the following claims.

That which is claimed is:

1. A system for facilitating sale of a domain name comprising:
a database for storing records of domain names listed for sale by sellers;
a web server operatively connected with the database and configured to provide interactive means for receiving purchase inquiries from buyers;
wherein the web server is configured to host the domain names listed for sale and to selectively provide to visitors to the domain name, (i) a sales inquiry form and (ii) an inquiry confirmation display, in dependence on whether the visitor has previously submitted a sales inquiry.

2. The system of claim 1 further comprising:
a messaging interface operatively connected with the web server to (i) send a notification to a seller when a purchase inquiry has been made by a buyer, (ii) receive a response to the inquiry from the seller, and wherein the web server is further configured to display the response on the confirmation display.
